(19) United States
(12) Patent Application Publication
(10) Pub. No.: US 2018/0279675 A1
(43) Pub. Date: Oct. 4, 2018

(54) ELECTRONIC CIGARETTE AND ATOMIZATION CONTROL METHOD THEREOF

(71) Applicant: HUIZHOU KIMREE TECHNOLOGY CO., LTD., Huizhou, Guangdong (CN)

(72) Inventor: Qiuming Liu, Shenzhen, Guangdong (CN)

(21) Appl. No.: 15/527,006

(22) PCT Filed: Nov. 14, 2014
(86) PCT No.: PCT/CN2014/091154

§ 371 Date: May 15, 2017

(51) Int. Cl. A24F 47/00; H05B 3/46

(52) U.S. Cl. CPC A24F 47/008; H05B 3/46

(57) ABSTRACT

The present invention is disclosed an electronic cigarette and an atomization control method thereof. The electronic cigarette comprises an atomization assembly, a battery assembly and a control module connected to a power source in the battery assembly and a heating wire assembly in the atomization assembly; a first conductive sleeve is provided on an outer peripheral surface of the battery assembly; a second conductive sleeve is provided on an outer peripheral surface of a suction nozzle. The electronic cigarette is actuated when the conductive sleeves arranged at different positions are in contact with the human skin, so as to reduce probability of false triggering of the electronic cigarette; and during use, this structure conforms to the users' habit of smoking by holding the battery assembly in their fingers and holding the suction nozzle in their mouths, which is convenient for the user and improves user experience.

### FIELD OF THE INVENTION

The present application relates to a technical field of an electronic cigarette, and more particularly relates to an electronic cigarette and an atomization control method thereof.

### BACKGROUND OF THE INVENTION

In the prior art, electronic cigarettes generally comprise two parts which are an atomization assembly for atomizing e-liquid and a battery assembly for supplying power to the atomization assembly. Among them, an existing electronic cigarette integrated an airflow sensor with a control circuit to control the electronic cigarette, when the user smoking electronic cigarette, the electronic cigarette air pressure will change, resulting in deformation of a thin film capacitor of the airflow sensor. When the amount of the deformation of the thin film capacitor reaches a threshold, a trigger signal is sent to the microprocessor in the control circuit to ensure the microprocessor to control the battery assembly to supply power to the atomization assembly to atomize e-liquid.

However, such an electronic cigarette in a packaging or transport process, is prone to cause a change of the air pressure in the electronic cigarette, which causes the electronic cigarette to work automatically. The electronic cigarette automatically working for a long time is likely to cause a risk of fire and explosion, while the electronic cigarette automatically working for a long time leads to a problem that deterioration and taste of the atomized e-liquid are changed after the atomized e-liquid is repeatedly oxidized by the air. In addition, the prior art described above requires that the air channel on the atomization assembly communicates with the airflow passage of the airflow sensor, and currently the airflow sensor is mounted at one end opposite to the atomization assembly, in a working process of the electronic cigarette, the e-liquid on the atomization assembly will flow along the air channel to the battery within battery assembly and the airflow sensor, it will damage the airflow sensor and battery, causing the battery a short circuit or inoperation and so on.

Another existing electronic cigarette is to replace the airflow sensor through a mechanical key switch to control the electronic cigarette to achieve an atomization of the liquid. Because a frequency of pressing the key switch is high when smoking the electronic cigarette, the key switch is likely to fail during a long pressing process, then some electronic cigarettes are controlled by using touch switches instead of the above key switches. However, a touch switch is usually provided at a certain position on an outer peripheral surface of the battery assembly, and as long as the touch switch is touched, the electronic cigarette is operated, it is easy to touch the touch switch when packaging or holding the electronic cigarette, thereby leading to an automatic work situation of the electronic cigarette.

### SUMMARY OF THE INVENTION

Technical problems to be solved in the present invention is to provide an electronic cigarette and an atomization control method thereof aiming at defects in the prior art.

A technical proposal for solving the technical problem of the invention is shown as following.

Provide an electronic cigarette comprising an atomization assembly and a battery assembly, a heating wire assembly is defined in the atomization assembly, the battery assembly is provided with a power source for supplying electrical power to the heating wire assembly so that the atomization assembly atomizes e-liquid to form smoke; the electronic cigarette further comprises a control module electrically connected to the power source and the heating wire assembly, respectively; a first conductive sleeve is provided on an outer peripheral surface of the battery assembly; a suction nozzle for a user to smoke is provided on an end of the atomization assembly opposite to the battery assembly; and a second conductive sleeve is provided on an outer peripheral surface of the suction nozzle; wherein one conductive sleeve of the first conductive sleeve and the second conductive sleeve is electrically connected to the control module and the other conductive sleeve is electrically connected to the power source;

The first conductive sleeve and the second conductive sleeve are contacted by the user's skin and then conducted while the user is smoking, the control module is configured for controlling the power source to supply the electrical power to the heating wire assembly to atomize the e-liquid when the control module detects that the first conductive sleeve and the second conductive sleeve are conducted.

In the electronic cigarette according to the present invention, the battery assembly comprises the first conductive sleeve, the first conductive sleeve receives a battery configured as the power source, one end of the first conductive sleeve is provided with a first connector for being detachably connected the atomization assembly, the other end of the first conductive sleeve is provided with an end cap configured for covering the first conductive sleeve.

In the electronic cigarette according to the present invention, the battery assembly comprises a battery case, the first conductive sleeve is sleeved on the battery case and covers an entire outer peripheral surface of the battery case, the battery case receives a battery configured as the power source, one end of the battery case is provided with a first connector for being detachably connected the atomization assembly, the other end of the battery case is provided with an end cap configured for covering the first conductive sleeve.

In the electronic cigarette according to the present invention, the first conductive sleeve is made of a conductive paper; an outer peripheral surface of the atomization assembly is provided with an insulating paper defined coaxially with the first conductive sleeve, the insulating paper is sleeved between the first conductive sleeve and the second conductive sleeve.

In the electronic cigarette according to the present invention, the battery assembly and the atomization assembly are detachably connected, and the detachable connection between the battery assembly and the atomization assembly is a threaded connection structure or an interlocking connection structure.

In the electronic cigarette according to the present invention, the atomization assembly comprises an atomization sleeve, the suction nozzle is provided at one end of the atomization sleeve opposite to the battery assembly, the other end of the atomization sleeve is provided with a second connector detachably connected to the first connector, the first connector is electrically connected to the battery and the second connector, respectively.

In the electronic cigarette according to the present invention, a first electrode assembly is fixed in the second connector, and a second electrode assembly resiliently abutted against and electrically connected to the first electrode assembly is fixed in the first connector; the second electrode assembly is electrically connected to the battery; the first electrode assembly comprises a first insulating sleeve, a first electrode, a second insulating sleeve and a second electrode successively connected from outside to inside.

In the electronic cigarette according to the present invention, the second electrode assembly comprises a third insulating sleeve, a third electrode, a fourth insulating sleeve and a fourth electrode which are successively connected from outside to inside, the second electrode and the fourth electrode are elastically abutted against and electrically connected to each other; and the second electrode or the fourth electrode is a spring electrode.

In the electronic cigarette according to the present invention, the second electrode assembly comprises an insulating base, and a third electrode and a fourth electrode, the third electrode and the fourth electrode are embedded in the insulating base with a space between each other; the third electrode and the fourth electrode are spring electrodes, the third electrode is elastically abutted against and electrically connected to the first electrode, the fourth electrode is elastically abutted against and electrically connected to the second electrode.

In the electronic cigarette according to the present invention, the atomization assembly further comprises an atomization seat fixed in the atomization sleeve, the heating wire assembly is fixed on the atomization seat; the heating wire assembly comprises an e-liquid guide for adsorbing e-liquid and a heating wire for atomizing the e-liquid on the e-liquid guide; two ends of the heating wire are electrically connected to the second connector and the first electrode, respectively, to realize an electrical connection to the battery assembly.

In the electronic cigarette according to the present invention, the atomization sleeve is provided with an airflow passage communicating with the suction nozzle and enabling airflow to flow, an air inlet communicating with the airflow passage is defined on an abutting surface between the second connector and the first connector.

In the electronic cigarette according to the present invention, the airflow passage comprises a vent hole defined in the atomization seat, the airflow is discharged from the suction nozzle by sequentially passing through the air inlet and the vent hole.

In the electronic cigarette according to the present invention, the control module comprises a conductive sleeve conduction signal detection circuit, a microprocessor, a transistor switch unit, the transistor switch unit is electrically connected to the microprocessor and the heating wire assembly;

The conductive sleeve conduction signal detection circuit is configured for detecting whether or not the first conductive sleeve and the second conductive sleeve are conducted, and transmitting a trigger signal generated by the conduction to the microprocessor, the microprocessor is configured for controlling an on/off state of the transistor switch unit in accordance with the trigger signal to control whether the atomization assembly atomizes the e-liquid.

In the electronic cigarette according to the present invention, the conductive sleeve conduction signal detection circuit comprises a filter circuit electrically connected to the second conductive sleeve for filtering an input signal, and a transistor switching circuit electrically connected an output end of the filter circuit, the transistor switching circuit is configured to receive a conduction signal after filtering and output a switching signal to the microprocessor.

In the electronic cigarette according to the present invention, the filter circuit comprises a first resistor, a second resistor, a first capacitor and a second capacitor, a common terminal of the first resistor, the first capacitor and the second capacitor is grounded, the other end of the first resistor, the other end of the first capacitor and one end of the second resistor are electrically connected to the second conductive sleeve, the other end of the second resistor and the other end of the second capacitor are connected to the transistor switching circuit.

In the electronic cigarette according to the present invention, the transistor switching circuit comprises a first transistor, a second transistor, a third resistor, a fourth resistor and a fifth resistor; a base of the first transistor is connected with the filter circuit, an emitter of the first transistor is grounded, a collector of the first transistor is connected to one end of the third resistor and one end of the fourth resistor, the other end of the third resistor is electrically connected to the power source, and the other end of the fourth resistor is connected to a base of the second transistor, an emitter of the second resistor is electrically connected to the power source, a collector of the second resistor is electrically connected to the one end of fifth resistor and the microprocessor, and the other end of the fifth resistor is grounded.

In the electronic cigarette according to the present invention, the conductive sleeve conduction signal detection circuit comprises a filter circuit electrically connected to the second conductive sleeve for filtering an input signal, and a comparison circuit electrically connected to an output terminal of the filter circuit, a positive input terminal of the comparison circuit receives a conduction signal after filtering and outputs a comparison result signal to the microprocessor.

In the electronic cigarette according to the present invention, the battery assembly is provided with a battery configured as the power source; one conductive sleeve selected from both the first conductive sleeve and the second conductive sleeve is electrically connected to a positive electrode of the battery.

In the electronic cigarette according to the present invention, the atomization assembly and the battery assembly are arranged coaxially.

The present invention further provides an atomization control method of an electronic cigarette, the electronic cigarette comprises an atomization assembly and a battery assembly, a heating wire assembly is defined in the atomization assembly, the battery assembly is provided with a power source for supplying electrical power to the heating wire assembly so that the atomization assembly atomizes the e-liquid to form smoke; the electronic cigarette further comprises a control module electrically connected to the power source and the heating wire assembly, respectively; a first conductive sleeve electrically connected to the power source is provided on an outer peripheral surface of the battery assembly; a suction nozzle for a user to smoke with is provided on an end of the atomization assembly opposite to the battery assembly; and a second conductive sleeve electrically connected to the control module is provided on an outer peripheral surface of the suction nozzle; the control method comprises following steps:

S1. conducting the first conductive sleeve and the second conductive sleeve by user's skin when the user contacts the first conductive sleeve and the second conductive sleeve through the skin simultaneously;

S2. controlling the power source to supply the electrical power to the heating wire assembly to atomize e-liquid when the control module detects that the first conductive sleeve and the second conductive sleeve are conducted.

Generally, applications of the electronic cigarette and the atomization control method thereof of the present invention have following advantages: the first conductive sleeve is provided on the outer peripheral surface of the battery assembly, and the atomization assembly is provided with the suction nozzle for smoking at one end opposite to the battery assembly, the outer peripheral surface of the suction nozzle is provided with a second conductive sleeve, when smoking, the user directly holds on the first conductive sleeve by fingers, a mouth is held on the suction nozzle, so as to realize contacts between the conductive sleeves at different positions on the outer surface of the electronic cigarette and the user's skin at the same time, and to transmit the conduction signal to the control module so that the control module controls the power source to supply the heating wire assembly to atomize the e-liquid and starts the electronic cigarette to work. Therefore, the present invention can reduce a probability that the electronic cigarette is mistakenly triggered, effectively solves the problem in the prior art that the electronic cigarette works when the key switch, the touch switch or the airflow sensor is often mistakenly triggered, resulting in a change of deterioration of taste of the e-liquid of the electronic cigarette caused by repeated oxidization and, a short electronic cigarette life, low safety and other issues. Moreover, by providing the structure of the present invention, it is possible to reduce conditions of the packaging apparatus for transporting the electronic cigarette, thus to facilitate the transportation and the transportation is more secure. In addition, during a using process, the structure meets user requirements that the user can smoke when the fingers are held on the battery assembly and the mouth is held on the suction nozzle, it is more user-friendly, improves user experience, so as to avoid a complex using problem that the touch keys or switches are needed to be touched in the prior art, and to avoid the problem that the airflow sensor can not detect the smoke signal when the smoking force is small, the e-liquid enters the battery assembly from the airflow channel, and other problems.

### BRIEF DESCRIPTION OF THE DRAWINGS

The present invention will be further described with reference to the accompanying drawings and embodiments in the following.

FIG. 1 is a perspective view of an electronic cigarette provided by one of the preferred embodiments of the present invention;

FIG. 2 is a structural schematic view of the atomization assembly of the electronic cigarette shown in FIG. 1;

FIG. 3 is a structural schematic view of the battery assembly of the electronic cigarette shown in FIG. 1;

FIG. 4 is a structural schematic view of the electronic cigarette shown in FIG. 1;

FIG. 5 is an enlarged view of the A region in FIG. 4;

FIG. 6 is a perspective view of an electronic cigarette provided by a second embodiment of the preferred embodiments of the present invention;

FIG. 7 is a structural schematic view of the electronic cigarette shown in FIG. 6;

FIG. 8 is a structural schematic view of the control module of the electronic cigarette shown in FIG. 1;

FIG. 9 is a configuration diagram of the conductive sleeve conduction signal detection circuit of a first kind of the control module shown in FIG. 8;

FIG. 10 is a configuration diagram of the conductive sleeve conduction signal detection circuit of a second kind of the control module shown in FIG. 8;

FIG. 11 is a circuit diagram of a first kind of the control module shown in FIG. 8;

FIG. 12 is a circuit diagram of a second kind of the control module shown in FIG. 8.

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments.

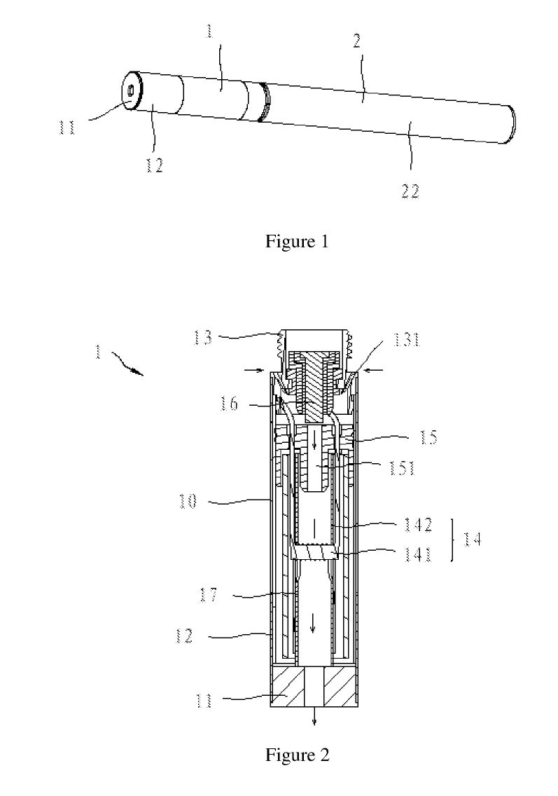

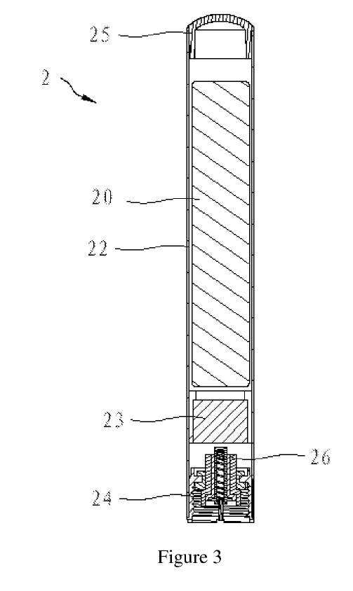

FIG. 1 shows an electronic cigarette provided by one of the preferred embodiments of the present invention, the electronic cigarette comprises an atomization assembly 1 and a battery assembly 2, the battery assembly 2 is electrically connected to the atomization assembly 1 and is configured for supplying electrical power to the atomization assembly 1. As shown in FIG. 3, the battery assembly 2 is provided with a power source for supplying electrical power to the heating wire assembly 14 so that the atomization assembly 1 atomizes e-liquid to form smoke; the battery assembly 2 further comprises a control module 23 electrically connected to the power source and the heating wire assembly 14, respectively; a first conductive sleeve 22 is provided on an outer peripheral surface of the battery assembly 2. As shown in FIG. 2, a suction nozzle 11 for a user to smoke with is provided on an end of the atomization assembly 1 opposite to the battery assembly 2; and a second conductive sleeve 12 is provided on an outer peripheral surface of the suction nozzle 11; one conductive sleeve of the first conductive sleeve 22 and the second conductive sleeve 12 is electrically connected to the control module 23 and the other conductive sleeve is electrically connected to the power source.

When the user is smoking, the user contacts the first conductive sleeve 22 and the second conductive sleeve 12 through skin, respectively, so that the first conductive sleeve 22 and the second conductive sleeve 12 are conducted, the control module 23 is configured for controlling the power source to supply the electrical power to the heating wire assembly 14 within a predetermined time to atomize e-liquid when the control module 23 detects that the first conductive sleeve 22 and the second conductive sleeve 12 are conducted.

In the present embodiment, the electronic cigarette senses contact between human skin and the first conductive sleeve 22 and the second conductive sleeve 23 to generate a conduction signal, and the conduction signal is transmitted to the control module 23, and the control module 23 controls the power source to supply the electrical power to the heating wire assembly 14 to atomize the e-liquid, so as to avoid a defect caused by that the conventional electronic cigarette uses the airflow sensor to sense a pressure change to deliver a sensing signal to the controller. Since the first conductive sleeve 22 and the second conductive sleeve 12 in the present embodiment are provided on the outer peripheral wall of the electronic cigarette, respectively, it is possible to prevent the conductive sleeve from being damaged by the e-liquid in the atomization assembly 1 and thereby causing a defect that the electronic cigarette is fail to operate properly, and it is easy to use.

As shown in FIG. 1, the first conductive sleeve 22 and the second conductive sleeve 12 are made of a conductive material, they are spaced from each other and defined on the outer peripheral wall of the electronic cigarette, the first conductive sleeve 22 is arranged on the outer peripheral wall of the battery assembly 2, while the second conductive sleeve 12 is defined on the outer peripheral wall of the atomization assembly 1. Preferably, the first conductive sleeve 22 and the second conductive sleeve 12 are made of a metallic material, so that the structure of the electronic cigarette is reliable. The metal material may be a material such as gold, silver, copper, iron or stainless steel, and is not particularly limited thereto.

As shown in FIG. 3, the battery assembly 2 comprises the first conductive sleeve 22, the first conductive sleeve 22 receives a battery 20 configured as the power source, one end of the first conductive sleeve 22 is provided with a first connector 24 for being detachably connected the atomization assembly 1, the other end of the first conductive sleeve 22 is provided with an end cap 25 configured for covering the first conductive sleeve 22. Since the user normally holds on the battery assembly 2 by fingers at the smoking time, the structure is not only simple and compact, but also allows the user to well contact the first conductive sleeve 22 during using, and it prevents the first conductive sleeve 22 defined at one point of the battery assembly from being difficultly to be contacted with.

Understandably, in other embodiments, the battery assembly 2 can further comprise a battery case (no shown in figures), the first conductive sleeve 22 is sleeved on the battery case and covers an entire outer peripheral surface of the battery case. Specifically, the first conductive sleeve 22 is made of a conductive paper, the battery case receives a battery 20 configured as the power source, one end of the battery case is provided with a first connector 24 for being detachably connected the atomization assembly 1, the other end of the battery case is provided with an end cap 25 configured for covering the first conductive sleeve 22. The present embodiment does not limit a specific structure of the first conductive sleeve 22 as long as it can be provided on the outer peripheral surface of the battery assembly 2 and is electrically connected to the control module 23 or the battery 20 of the electronic cigarette. The conductive paper can not only imitate a real cigarette, but also improve the user's comfort.

As shown in FIG. 2, the atomization assembly 1 comprises an atomization sleeve 10, the suction nozzle 11 is provided at one end of the atomization sleeve 10 opposite to the battery assembly 2, the second conductive sleeve 12 is sleeved on an outer peripheral surface of the atomization sleeve 10, and the second conductive sleeve 12 is spaced with the first conductive sleeve 22 in the battery assembly 2 to ensure an electrical insulation between the first conductive sleeve 22 and the second conductive sleeve 12. By providing the second conductive sleeve 12 on the suction nozzle 11, it is possible to make it easy for the user to ensure that the second conductive sleeve 12 comes into contact with the user's skin when smoking, and it is more convenient for user to use and thereby improves the user's experience.

Preferably, an outer peripheral surface of the atomization assembly 1 is provided with an insulating paper sleeve (not shown in figures) defined coaxially with the first conductive sleeve 22 and the second conductive sleeve 12, the insulating paper sleeve is located between the first conductive sleeve 22 and the second conductive sleeve 12.

It is preferred that the second conductive sleeve 12 is defined at one end of the atomization sleeve 10 opposite to the battery assembly 2, and is coated on an entire outer peripheral surface of the suction nozzle 11.

It is preferred that the second conductive sleeve 12 is defined at one end of the atomization sleeve 10 opposite to the battery assembly 2, and is integrally formed with the suction nozzle 11, and the atomization assembly 1 and the battery assembly 2 are arranged coaxially.

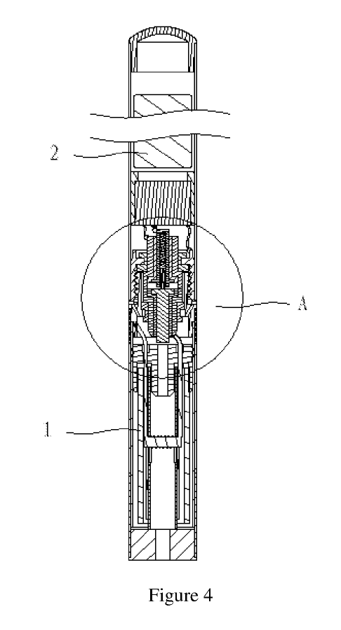

A specific structure of the atomization assembly 1 will be described in detail with reference to the embodiments shown in FIGS. 2, 4 and 5.

As shown in FIG. 2, the atomization assembly 1 comprises the atomization sleeve 10, the suction nozzle 11, the second conductive sleeve 12, a second connector 13, a heating wire assembly 14, an atomization seat 15, a first electrode assembly 16, and a vent tube 17.

The suction nozzle 11 and the second connector 13 are provided at two ends of the atomization sleeve 10 respectively, the second conductive sleeve 12 is coated on the outer peripheral surface of the suction nozzle 11 and is electrically connected to the first electrode assembly 16, the atomization seat 15 is accommodated in the atomization sleeve 10, and the vent tube 17 is fixed to the atomization seat 15, and the heating wire assembly 14 is fixed to the vent tube 17.

Specifically, the atomization sleeve 10 is generally a hollow cylindrical structure, and the suction nozzle 11 is fixed at the end of the atomization sleeve 10 opposite to the battery assembly 2, and an air outlet (not shown) communicating with the vent tube 17 is defined on the suction nozzle 11, smoke atomized by the heating wire assembly 14 is discharged from the air outlet for the user to inhale.

In the present embodiment, the suction nozzle 11 is made of an elastic material such as silica gel or the like to facilitate the user's smoking. An electric wire (not shown in figures) is clamped between the suction nozzle 11 and the second conductive sleeve 12, and the second conductive sleeve 12 is electrically connected to the first electrode assembly 16 through the electric wire and an electrical connection with the control module 23 of the electronic cigarette is realized via the first electrode assembly 16.

The second conductive sleeve 12 is provided on the outer peripheral surface of the suction nozzle 11, the present embodiment does not define a specific position of the second conductive sleeve 12 as long as it is electrically isolated from the first conductive sleeve 22 and is electrically connected to the control module 23 or the battery 20 of the electronic cigarette.

The second connector 13 is fixed to the end of the atomization sleeve 10 close to the battery assembly 2, the second connector 13 is detachably connected to the battery assembly 2 and electrically connected to the battery assembly 2, the second connector 13 is made of a conductive material. In the present embodiment, the detachable connection structure between the second connector 13 and the battery assembly 2 is a threaded connection structure. Specifically, one end of the second connector 13 is inserted and fixed in the atomization sleeve 10, and one end of the second connector 13 extending from the atomization sleeve 10 is provided with an external thread structure. The present embodiment does not define a specific structure of a detachable connection between the second connector 13 and the battery assembly 2, and it may be other connecting structures such as an interlocking connection structure.

Further, an air inlet 131 for airflow to flow is defined on an abutting surface between the second connector 13 and the battery assembly 2.

The atomization seat 15 is fixed in the atomization sleeve 10 and is in interference with an inner side wall of the atomization sleeve 10 so as to prevent the atomization seat 15 from rocking in the atomization sleeve 10 to cause damage to the components within the atomization sleeve 10.

Further, a vent hole 151 for the airflow flowing is defined along the axial direction on the atomization seat 15, and the vent hole 151 is communicated with the air inlet 131 on the second connector 13. A side of the vent hole 151 toward the suction nozzle 11 is convexly provided with an annular boss (not shown in figures) communicated with the vent hole 151.

The vent pipe 17 is sleeved and fixed to the annular boss of the atomization seat 15, two oppositely arranged mounting holes (not shown in figures) are separately defined on the vent pipe 17, the heating wire assembly 14 is provided on the two mounting holes, and the vent pipe 17 is provided with an e-liquid storage cotton (not shown in figures) for storing the e-liquid and supplying the e-liquid to the heating wire assembly.

Further, the atomization sleeve 10 is provided with an airflow passage communicating with the suction nozzle 11 and for the airflow flowing, and the airflow passage comprises the air inlet 131, the vent hole 151 and the vent pipe 17 which are sequentially communicated. The airflow passes through the air inlet 131, the vent hole 151 and the vent pipe 17 in this order, and is discharged from the air outlet of the suction nozzle 11 for the user to inhale.

The heating wire assembly 14 comprises an e-liquid guide 141 and a heating wire 142, the e-liquid guide 141 is made of an e-liquid absorbing material and is defined and fixed to the mounting holes of the vent pipe 17, the heating wire 142 is wound on the e-liquid guide 141 and is electrically connected to the first electrode assembly 16. Since the heating wire assembly 14 is a conventional means of the prior art, the specific structure thereof will not be described here.

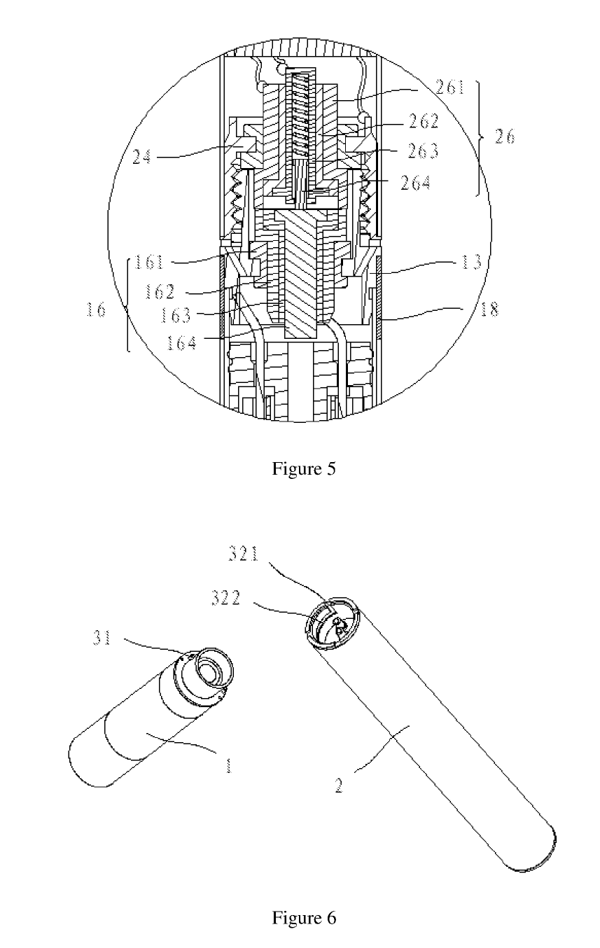

A first electrode assembly 16 is fixed in the second connector 13, and is configured for electrically connecting with the battery assembly 2; as shown in FIG. 5, the first electrode assembly 16 comprises a first insulating sleeve 161, a first electrode 162, a second insulating sleeve 163 and a second electrode 164 successively connected from outside to inside. In the present embodiment, two ends of the heating wire 142 are electrically connected to the second connector 13 and the first electrode 162, respectively, the second conductive sleeve 12 is electrically connected to the second electrode 164 through an electric wire (not shown in figures). Certainly, the structure of the atomization assembly described above is not limited to the above-described structure as long as it has ability to atomize the e-liquid, and is not particularly limited thereto.

A specific structure of the battery assembly 2 will be described in detail with reference to the embodiment shown in FIGS. 3, 4 and 5.

As shown in FIG. 3, the battery assembly 2 comprises the battery 20, the first conductive sleeve 22, the control module 23, the first connector 24, a second electrode assembly 26, and an end cap 25.

The battery 20 is fixed in the first conductive sleeve 22, the control module 23 is fixed in the first conductive sleeve 22 and is electrically connected to the battery 20. The first connector 24 and the end cap 25 are provided at two ends of the first conductive sleeve 22, respectively, the second electrode assembly 26 is fixed in the first connector 24 and is electrically connected to the battery 20 and the control module 23, respectively.

Specifically, the first conductive sleeve 22 is generally a hollow cylindrical structure, the end cap 25 is fixed at one end of the first conductive sleeve 22 opposite to the atomization assembly 1, and the end cap 25 is made of a light-transmissive material. In the present embodiment, the first conductive sleeve 22 is electrically connected to the power source, i.e., the first conductive sleeve 22 is electrically connected to a positive electrode of the battery 20. Certainly, the power source 22 may be realized by a high-energy capacitor or the like, and is not particularly limited thereto.

The first connector 24 is firmly connected to one end of the first conductive sleeve 22 close to the atomization assembly 1 and configured for a detachable connection to the atomization assembly 1. Specifically, one end of the first connector 24 is inserted in the first conductive sleeve 22, and one end of the first connector 24 extending to the outside of the first conductive sleeve 22 is provided with an external thread structure for matching with an internal thread structure on the second connector 13.

Further, in order to increase stability between the first connector 24 and the second connector 13, it is also possible to sleeve a compression ring 17 on the first connector 24 as shown in FIG. 5 to prevent user experience from being effected by loosening between the connectors.

The second electrode assembly 26 is fixed in the first connector 24, and is resiliently abutted against and electrically connected to the first electrode assembly 16. As shown in FIG. 5, the second electrode assembly 26 comprises a third insulating sleeve 261, a third electrode 262, a fourth insulating sleeve 263 and a fourth electrode 264 which are successively connected from outside to inside, the first connector 24, the third electrode 262 and the fourth electrode 264 are electrically connected to the control module 23 through electric wires (not labeled in figures), respectively. The third electrode 262 is elastically abutted against and electrically connected to the first electrode 162, the fourth electrode 264 is elastically abutted against and electrically connected to the second electrode 164.

Further, in order to improve stability of the connection between the first electrode assembly 16 and the second electrode assembly 26, the second electrode 164 or the fourth electrode 264 may be provided as spring electrodes such that the first electrode assembly 16 is elastically abutted against the second electrode assembly 26.

Specifically, in the present embodiment, the fourth electrode 264 is a spring electrode. As shown in FIG. 5, the spring electrode comprises an outer sheath (not labeled in figures), and the outer sheath is provided with a groove (not labeled in figures), a spring and an electrical connector (all are not labeled in figures) are slidably connected to the groove. Specifically, one end of the spring is fixed to a bottom of the recess and the other end of the spring is fixedly connected to the electrical connector so that the electrical connector is slidably connected to the groove. When the atomization assembly 1 is connected to the battery assembly 2, the electrical connector is resiliently abutted against the second electrode 164. It will be appreciated that in other embodiments the second electrode 164 may also be a spring electrode such that the second electrode 164 is resiliently abutted against the fourth electrode 264.

The control module 23 is electrically connected to the second electrode assembly 26 and the battery 20, respectively, and is mainly configured for detecting whether the first conductive sleeve 22 and the second conductive sleeve 12 are conducted or not, and controlling the power source to supply the electrical power to the heating wire assembly 14 according to a detected conduction signal.

Specifically, when the first conductive sleeve 22 and the second conductive sleeve 12 are contacted simultaneously with user's skin, the user's skin enables the first conductive sleeve 22 and the second conductive sleeve 12 to be conducted; the control module 23 controls the power source to supply the electrical power to the heating wire assembly 14 to atomize e-liquid when the control module 23 detects that the first conductive sleeve 22 and the second conductive sleeve 12 are conducted.

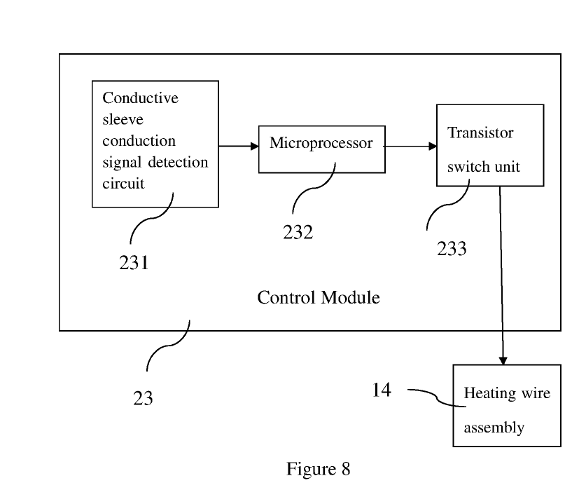

As shown in FIG. 8, the control module 23 comprises a conductive sleeve conduction signal detection circuit 231, a microprocessor 232, and a transistor switch unit 233, the microprocessor 232, and the transistor switch unit 233 are electrically connected to the microprocessor 232 and the heater wire assembly 14, respectively. The microprocessor 232 in the control module 23 may be set with a heating time parameter after conduction, for example, in the microprocessor 232, heating time is 2 to 10 ms after receiving the conduction signal, and this time period is set for a main consideration of electrical contact problems, smokers do not have to keep pressing the two conductive sleeves, but only need to press instantly at the beginning to generate an instantaneous conduction signal, even without a conduction signal during the time period, a heating time can be maintained, it can overcome a problem that the heating atomization is immediately turned off after being conducted by the human body as a release of the user, so as to facilitate a use of the user.

The conductive sleeve conduction signal detection circuit 231 is configured for detecting whether or not the first conductive sleeve 22 and the second conductive sleeve 12 are conducted, and transmitting a trigger signal generated after conduction to the microprocessor 232, the microprocessor 232 is configured for controlling an on/off state of the transistor switch unit 233 in accordance with the trigger signal to control whether the atomization assembly 1 atomizes the e-liquid.

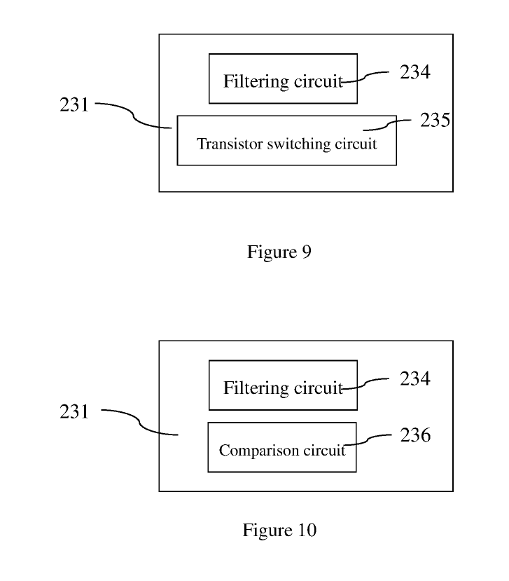

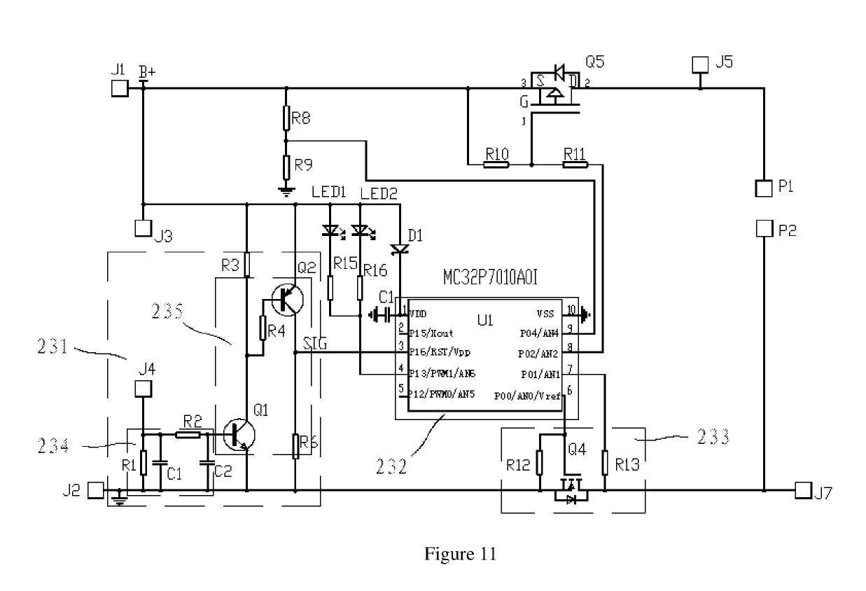

FIGS. 9 and 11 show a schematic structural view of the first control module 23 of the present embodiment, the conductive sleeve conduction signal detection circuit 231 comprises a filter circuit 234 and a transistor switching circuit 235. The filter circuit 234 is electrically connected to the second conductive sleeve 12 and is configured for filtering an input signal; the transistor switching circuit 235 is electrically connected to an output end of the filter circuit 234, the transistor switching circuit 235 is configured for receiving a sensing signal after filtering and outputting a switching signal configured as a trigger signal to the microprocessor 232.

Specifically, the filter circuit 234 comprises a first resistor R1, a second resistor R2, a first capacitor C1 and a second capacitor C2, a common terminal of the first resistor R1, the first capacitor C1 and the second capacitor C2 is grounded, the other end of the first resistor R1, the other end of the first capacitor C1 and one end of the second resistor R2 are electrically connected to the second conductive sleeve 12, the other end of the second resistor R2 and the other end of the second capacitor C2 are connected to the transistor switching circuit 235.

The transistor switching circuit 235 comprises a first transistor Q1, a second transistor Q2, a third resistor R3, a fourth resistor R4 and a fifth resistor R6; a base of the first transistor Q1 is connected with the filter circuit, an emitter of the first transistor Q1 is grounded, a collector of the first transistor Q1 is connected to one end of the third resistor R3 and one end of the fourth resistor R4, the other end of the third resistor R3 is electrically connected to the power source, and the other end of the fourth resistor R4 is connected to a base of the second transistor Q2, an emitter of the second transistor Q2 is electrically connected to the power source, a collector of the second transistor Q2 is electrically connected to one end of the fifth resistor R6 and one end of the microprocessor 232, and the other end of the fifth resistor R6 is grounded.

The microprocessor 232 is applied as a microcontroller U1 whose type is MC32P7010A0I, the transistor switch unit 233 comprises a field effect transistor Q4, the heating wire 142 is connected between P1 and P2, J3 is electrically connected to the first conductive sleeve 22 and electrically connected to the positive electrode of the battery 20, J4 is electrically connected to the second conductive sleeve 12. During operation, a portion of the human body contacts the second conductive sleeve 12, and the other portion of the human body contacts the first conductive sleeve 22. A specific working principle of the circuit is as follows: when the human body is not in contact, a collector of the transistor Q2 outputs a low level, that is, a signal SIG=logic 0; when someone contacts the first conductive sleeve 22 and the second conductive sleeve 12, a signal is firstly filtered by the filter circuit 234, then flows through the transistor Q1 to turn on the transistor Q1, and then the transistor Q2 is turned on, so that the signal SIG are changed into a high level, that is, the signal SIG=logic 1. When the microcontroller U1 detects a signal changed from the low level to the high level, it is known that someone wants to smoke, and the microcontroller U1 controls the field effect transistor Q4 to turn on, so that the heating wire 142 connected between P1 and P2 is electrically energized to atomize the e-liquid. In the present embodiment, the field effect transistor Q5 is always in an open state, certainly, the field effect transistor Q5 may be not required, and the structure thereof is not particularly limited thereto. In addition, in order to allow the user to make the electronic cigarette operate properly when smoking, it is also possible to provide one or more electric conductors electrically connected to J1, J5, J7, respectively, on the outer surface of the electronic cigarette.

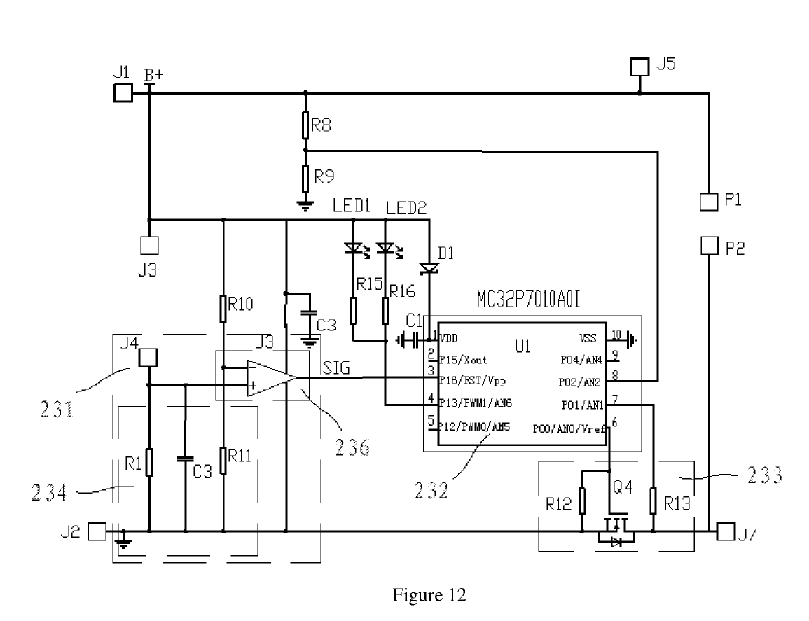

FIGS. 10 and 12 show a schematic structural view of the second control module 23 of the present embodiment, which differs from the first control module 23 in that the structure of the conductive sleeve conduction signal detection circuit 231 is different.

As shown in FIG. 12, the conductive sleeve conduction signal detection circuit 231 comprises a filter circuit 234 and a comparison circuit 236. The filter circuit 234 is electrically connected to the second conductive sleeve 12 and is used for filtering the input signal; The comparison circuit 236 is electrically connected to an output terminal of the filter circuit 234, the comparison circuit 236 comprises a comparator U3, a resistor R10 and a resistor R11, a reverse input terminal of the comparator U3 is electrically connected to a common terminal of the resistor R10 and the resistor R11, the resistor R10 and the resistor R11 are used to provide a divided voltage as a voltage reference to the reverse input terminal of the comparator U3; an output terminal of the comparator U3 is electrically connected to a pin 3 of the microprocessor 232, the other end of the resistor R10 is electrically connected to the first conductive sleeve 22 and the positive electrode of the battery, the other end of the resistor R11 is grounded, and a positive input terminal of the comparator U3 receives a filtered conductive signal and compares the filtered conductive signal with a reference voltage signal of the reverse input terminal, and an output terminal of the comparator U3 circuit outputs a comparison result signal as a trigger signal to the microprocessor 232.

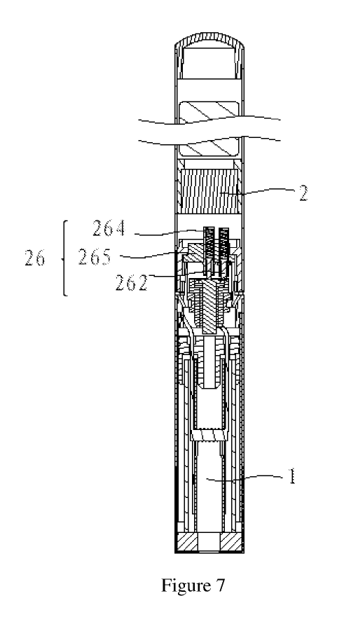

FIGS. 6 and 7 show an electronic cigarette provided in the second embodiment of the present invention, the second embodiment differs from the first embodiment in the structure of the second electrode assembly 26 and that the atomization assembly 1 is detachably connected to the battery assembly 2.

As shown in FIG. 7, the second electrode assembly 26 comprises an insulating base 265, and a third electrode 262 and a fourth electrode 264, the third electrode 262 and the fourth electrode 264 are embedded in the insulating base 265 with a space between each other; the third electrode 262 and the fourth electrode 264 are spring electrodes, the third electrode 262 is elastically abutted against and electrically connected to the first electrode 162, the fourth electrode 264 is elastically abutted against and electrically connected to the second electrode 164.

In the present embodiment, the third electrode 262 and the fourth electrode 264 are both spring electrodes, and a specific structure of the spring electrode is the same as that of the spring electrode in the first embodiment. Therefore, the specific structure of the spring electrode will not be described here.

As shown in FIG. 6, a detachable connection structure between the atomization assembly and the battery assembly 2 is an interlocking connection structure.

Specifically, the interlocking coupling structure comprises a buckle 31 and a slot 32 which are engaged with each other. The buckle 31 is convexly provided on the atomization assembly 1, and the slot 32 is provided on the battery assembly 2. In the present embodiment, the buckle 31 is protruded on an outer peripheral wall of the second connector 13, and the slot 32 is formed on an inner side wall of the first connector 24.

As shown in FIG. 6, the slot 32 is of a “L” shape, and the slot 32 comprises an insertion channel 321 and a rotation passage 322 which are smoothly connected to each other, the insertion channel 321 is provided at a port of the first connector 24 and axially extends along an axis of the first connector 24 toward a side opposite to the buckle 31, and the rotation passage 322 is connected to one end of the insertion passage 321 and extends along a circumferential direction of the first connector 24, the end of the insertion passage 321 is opposite to the buckle 31.

During assembling, the buckle 31 on the second connector 13 is firstly moved along the insertion passage 321 to the bottom end of the insertion passage 321, and then the atomization assembly 1 is rotated so that the buckle 31 is moved into the rotation passage 322, thereby realizing the detachable connection between the battery assembly 2 and of the atomization assembly 1. It is to be understood that the above-described arrangement between the atomization unit 1 and the battery assembly 2 is a detachable connection, certainly, the structure of the battery assembly 2 and the atomization unit 1 may be a un-detachable and integrated structure, namely, the electronic cigarette may be a disposable electronic cigarette, or an electronic cigarette capable of repeatedly adding e-liquid to be repeatedly used, and the structure thereof is not particularly limited thereto.

In this embodiment, the number of buckles 31 and slots 32 is two, and it is to be understood that the present application does not limit the specific number of buckles 31 and slots 32 as long as they enable an interlocking connection between the battery assembly 2 and the atomization assembly 1.

The present invention further provides an atomization control method of an electronic cigarette, the electronic cigarette is the above electronic cigarette, the atomization control method of an electronic cigarette comprises following steps:

S1. conducting the first conductive sleeve 22 and the second conductive sleeve 12 by user's skin when the user contacts the first conductive sleeve 22 and the second conductive sleeve 12 through the skin simultaneously;

S2. controlling the power source to supply the electrical power to the heating wire assembly 14 to atomize e-liquid when the control module 23 detects that the first conductive sleeve 22 and the second conductive sleeve 12 are conducted.

In general, the electronic cigarette and an atomization control method thereof of the present invention has following advantageous effects:

(1) In the present invention, the conduction signal is transmitted to the control module through contact between the conductive sleeves and the human skin, and then the control module controls the power source to supply the electrical power to the heating wire assembly to atomize the e-liquid to start the operation of the electronic cigarette. The present embodiment eliminates the airflow sensor to control the atomization of the e-liquid, and the battery assembly is a sealed structure, which can prevent the e-liquid from flowing into the battery assembly and avoid the short circuit, the automatic working or the non-operation of the electronic cigarette circuit due to the flow of the e-liquid into the battery assembly, meanwhile it can prevent the battery from being damaged caused by being soaked in the e-liquid.

(2) The air inlet is provided on the abutment surface where the second connector abuts against the first connector, and the airflow passage does not pass through the electrode assemblies, thereby preventing damage to the electrode assemblies.

(3) Since the atomization assembly is detachably connected to the battery assembly, it is convenient for the user to replace the atomization assembly after that the atomization assembly is damaged.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. An electronic cigarette comprising an atomization assembly (1) and a battery assembly (2), a heating wire assembly (14) is defined in the atomization assembly (1), wherein the battery assembly (2) is provided with a power source for supplying electrical power to the heating wire assembly (14) so that the atomization assembly (1) atomizes e-liquid to form smoke; wherein the electronic cigarette further comprises a control module (23) electrically connected to the power source and the heating wire assembly (14), respectively; a first conductive sleeve (22) is provided on an outer peripheral surface of the battery assembly (2); a suction nozzle (11) for a user to smoke is provided on an end of the atomization assembly (1) opposite to the battery assembly (2); and a second conductive sleeve (12) is provided on an outer peripheral surface of the suction nozzle (11); wherein one conductive sleeve of the conductive sleeve (22) and the second conductive sleeve (12) is electrically connected to the control module (23) and the other conductive sleeve is electrically connected to the power source; and
wherein the first conductive sleeve (22) and the second conductive sleeve (12) are contacted and then conducted by the user's skin while the user is smoking, so that the first conductive sleeve (22) and the second conductive sleeve (12) are conducted, the control module (23) is configured for controlling the power source to supply the electrical power to the heating wire assembly (14) to atomize the e-liquid when the control module (23) detects that the first conductive sleeve (22) and the second conductive sleeve (12) are conducted.

2. The electronic cigarette according to claim 1, wherein the battery assembly (2) comprises the first conductive sleeve (22), the first conductive sleeve (22) receives a battery (20) configured as the power source, one end of the first conductive sleeve (22) is provided with a first connector (24) for being detachably connected the atomization assembly (1), the other end of the first conductive sleeve (22) is provided with an end cap (25) configured for covering the first conductive sleeve (22).

3. The electronic cigarette according to claim 1, wherein the battery assembly (2) comprises a battery case, the first conductive sleeve (22) is sleeved on the battery case and covers an entire outer peripheral surface of the battery case, the battery case receives a battery (20) configured as the power source, one end of the battery case is provided with a first connector (24) for being detachably connected the atomization assembly (1), the other end of the battery case is provided with an end cap (25) configured for covering the first conductive sleeve (22).

4. The electronic cigarette according to claim 3, wherein the first conductive sleeve (22) is made of a conductive paper; an outer peripheral surface of the atomization assembly (1) is provided with an insulating paper defined coaxially with the first conductive sleeve (22), the insulating paper is sleeved between the first conductive sleeve (22) and the second conductive sleeve (12).

5. The electronic cigarette according to claim 1, wherein the battery assembly (2) and the atomization assembly (1) are detachably connected, and the detachable connection between the battery assembly (2) and the atomization assembly (1) is a threaded connection structure or an interlocking connection structure.

6. The electronic cigarette according to claim 2, wherein the atomization assembly (1) comprises an atomization sleeve (10), the suction nozzle (11) is provided at one end of the atomization sleeve (10) opposite to the battery assembly (2), the other end of the atomization sleeve (10) is provided with a second connector (13) detachably connected to the first connector (24), the first connector (24) is electrically connected to the battery (20) and the second connector (13), respectively.

7. The electronic cigarette according to claim 6, wherein a first electrode assembly (16) is fixed in the second connector (13), and a second electrode assembly (26) resiliently abutted against and electrically connected to the first electrode assembly (16) is fixed in the first connector (24); the second electrode assembly (26) is electrically connected to the battery (20); the first electrode assembly (16) comprises a first insulating sleeve (161), a first electrode (162), a second insulating sleeve (163) and a second electrode (164) which are successively connected from outside to inside.

8. The electronic cigarette according to claim 7, wherein the second electrode assembly (26) comprises a third insulating sleeve (261), a third electrode (262), a fourth insulating sleeve (263) and a fourth electrode (264) which are successively connected from outside to inside, the second electrode (164) and the fourth electrode (264) are elastically abutted against and electrically connected to each other; and the second electrode (164) or the fourth electrode (264) is a spring electrode.

9. The electronic cigarette according to claim 7, wherein the second electrode assembly (26) comprises an insulating base (265), and a third electrode (262) and a fourth electrode (264), the third electrode (262) and the fourth electrode (264) are embedded in the insulating base (265) with a space between each other; the third electrode (262) and the fourth electrode (264) are spring electrodes, the third electrode (262) is elastically abutted against and electrically connected to the first electrode (162), the fourth electrode (264) is elastically abutted against and electrically connected to the second electrode (164).

10. The electronic cigarette according to claim 7, wherein the atomization assembly (1) further comprises an atomization seat (15) fixed in the atomization sleeve (10), the heating wire assembly (14) is fixed on the atomization seat (15); the heating wire assembly (14) comprises an e-liquid guide (141) for adsorbing e-liquid and a heating wire (142) for atomizing the e-liquid on the e-liquid guide (141); two ends of the heating wire (142) are electrically connected to the second connector (13) and the first electrode (162), respectively, to realize an electrical connection to the battery assembly (2).

11. The electronic cigarette according to claim 10, wherein the atomization sleeve (10) is provided with an airflow passage communicating with the suction nozzle (11) and enabling airflow to flow, an air inlet (131) communicating with the airflow passage is defined on an abutting surface between the second connector (13) and the first connector (24).

12. The electronic cigarette according to claim 11, wherein the airflow passage comprises a vent hole (151) defined in the atomization seat (15), the airflow is discharged from the suction nozzle (11) by sequentially passing through the air inlet (131) and the vent hole (151).

13. The electronic cigarette according to claim 1, wherein the control module (23) comprises a conductive sleeve conduction signal detection circuit (231), a microprocessor (232), a transistor switch unit (233), the transistor switch unit (233) is electrically connected to the microprocessor (232) and the heating wire assembly (14);
wherein the conductive sleeve conduction signal detection circuit (231) is configured for detecting whether or not the first conductive sleeve (22) and the second conductive sleeve (12) are conducted, and transmitting a trigger signal generated by the conduction to the microprocessor (232), the microprocessor (232) is configured for controlling an on/off state of the transistor switch unit (233) in accordance with the trigger signal to control whether the atomization assembly (1) atomizes the e-liquid.

14. The electronic cigarette according to claim 13, wherein the conductive sleeve conduction signal detection circuit (231) comprises a filter circuit (234) electrically connected to the second conductive sleeve (12) for filtering an input signal, and a transistor switching circuit (235) electrically connected an output end of the filter circuit (234), the transistor switching circuit (235) is configured to receive a conduction signal after filtering and output a switching signal to the microprocessor (232).

15. The electronic cigarette according to claim 14, wherein the filter circuit (234) comprises a first resistor (R1), a second resistor (R2), a first capacitor (C1) and a second capacitor (C2), a common terminal of the first resistor (R1), the first capacitor (C1) and the second capacitor (C2) is grounded, the other end of the first resistor (R1), the other end of the first capacitor (C1) and one end of the second resistor (R2) are electrically connected to the second conductive sleeve (12), the other end of the second resistor (R2) and the other end of the second capacitor (C2) are connected to the transistor switching circuit (235).

16. The electronic cigarette according to claim 14, wherein the transistor switching circuit (235) comprises a first transistor (Q1), a second transistor (Q2), a third resistor (R3), a fourth resistor (R4) and a fifth resistor (R6); a base of the first transistor (Q1) is connected with the filter circuit, an emitter of the first transistor (Q1) is grounded, a collector of the first transistor (Q1) is connected to one end of the third resistor (R3) and one end of the fourth resistor (R4), the other end of the third resistor (R3) is electrically connected to the power source, and the other end of the fourth resistor (R4) is connected to a base of the second transistor (Q2), an emitter of the second transistor (Q2) is electrically connected to the power source, a collector of the second transistor (Q2) is electrically connected to one end of the fifth resistor (R6) and the microprocessor (232), and the other end of the fifth resistor (R6) is grounded.

17. The electronic cigarette according to claim 13, wherein the conductive sleeve conduction signal detection circuit (231) comprises a filter circuit (234) electrically connected to the second conductive sleeve (12) for filtering an input signal, and a comparison circuit (236) electrically connected to an output terminal of the filter circuit (234), a positive input terminal of the comparison circuit (236) receives a conduction signal after filtering and outputs a comparison result signal to the microprocessor (232).

18. The electronic cigarette according to claim 1, wherein the battery assembly (2) is provided with a battery (20) configured as the power source; the one conductive sleeve selected from both the first conductive sleeve (22) and the second conductive sleeve (12) is electrically connected to a positive electrode of the battery (20).

19. The electronic cigarette according to claim 1, wherein the atomization assembly (1) and the battery assembly (2) are arranged coaxially.

20. An atomization control method of an electronic cigarette, the electronic cigarette comprises an atomization assembly (1) and a battery assembly (2), wherein a heating wire assembly (14) is defined in the atomization assembly (1), the battery assembly (2) is provided with a power source for supplying electrical power to the heating wire assembly (14) so that the atomization assembly (1) atomizes the e-liquid to form smoke; wherein the electronic cigarette further comprises a control module (23) electrically connected to the power source and the heating wire assembly (14), respectively; a first conductive sleeve (22) electrically connected to the power source is provided on an outer peripheral surface of the battery assembly (2); a suction nozzle (11) for a user to smoke with is provided on an end of the atomization assembly (1) opposite to the battery assembly (2); and a second conductive sleeve (12) electrically connected to the control module (23) is provided on an outer peripheral surface of the suction nozzle (11); the control method comprises following steps:
S1. conducting the first conductive sleeve (22) and the second conductive sleeve (12) by user's skin when the user contacts the first conductive sleeve (22) and the second conductive sleeve (12) through the skin simultaneously;
S2. controlling the power source to supply the electrical power to the heating wire assembly (14) to atomize e-liquid when the control module (23) detects that the first conductive sleeve (22) and the second conductive sleeve (12) are conducted.
